(19) United States
(12) Patent Application Publication
(10) Pub. No.: US 2005/0231674 A1
(43) Pub. Date: Oct. 20, 2005

(54) Liquid crystal display device, method of manufacturing the same, and electronic apparatus

(76) Inventor: Joji Nishimura, Matsumoto (JP)

Correspondence Address: HARNESS, DICKEY & PIERCE, P.L.C., P.O. BOX 828, BLOOMFIELD HILLS, MI, 48303, US

(21) Appl. No.: 11/103,926

(22) Filed: Apr. 12, 2005

(30) Foreign Application Priority Data
Apr. 15, 2004 (JP) 2004-120321

(51) Int. Cl. G02F 1/1343

(52) U.S. Cl. 349/139; 349/130

(57) ABSTRACT

A liquid crystal display device with liquid crystal in a vertical alignment mode. A pixel electrode 31 has a plurality of island-shaped portions 31a, 31b, and 31c and connecting portions 39 for connecting the plurality of island-shaped portions in each dot region. At the centers of sub-dot regions S1, S2, and S3 respectively composed of the island-shaped portions, concave portions are formed in an interlayer insulating film on a lower substrate, and the pixel electrodes are provided along inner surfaces of the concave portions in the interlayer insulating film, thereby forming concave portions 73 for alignment control. One of the plurality of concave portions 73 also serves as a contact hole 72 in each dot region.

### TECHNICAL FIELD

The present invention relates to liquid crystal display devices having homeotropic liquid crystal.

### BACKGROUND ART

A transflective liquid crystal display device has a problem in that a viewing angle is narrow in a transmissive display mode. This is because there is a restriction that a reflective display must be performed using only one polarizing plate provided on the observer side since a transflective plate is provided on the inner surface of liquid crystal cells so that parallax is not generated, which results in a low degree of freedom on optical design.

Japanese Unexamined Patent Application Publication No. 2002-202511 discloses a transmissive liquid crystal display device adopting the vertical alignment mode. Each pixel is divided into a plurality of sub-pixels to divide one pixel into multi-domains. The shape of the sub-pixel is rotationally symmetric (for example, a substantially circular shape, a substantially rectangular shape, or a substantially star shape).

A protrusion is provided at the center of the aperture or the center of each sub-pixel on the lower substrate. The liquid crystal molecules align radially around the protrusion. This improves alignment regulating force and widens the viewing angle.

Japanese Unexamined Patent Application Publication No. 2002-202511 discloses that concave portions can be formed in the counter electrode in addition to the protrusion on the lower substrate. The concave portions in the counter electrode are located at positions that correspond to the protrusions. With this configuration, the liquid crystal molecules become radially aligned with respect to the center of the sub-pixel. A wide viewing angle is achieved as a result. A chiral agent is also added to control the alignment direction of the liquid crystal molecules, and thus color irregularity caused by an alignment defect is prevented.

### SUMMARY

When such alignment configuration is provided to both substrates, the substrates need to be more precisely aligned when bonded together. That is, even a slight positional deviation between the two substrates would bring the concave portions in the counter electrode out of alignment with the alignment protrusions of the lower substrate. This positional deviation would have a bad effect on the alignment of liquid crystal and causes a defect in arrangement, which results in the generation of color irregularity and an after image and the lowering of a response speed.

In active matrix liquid crystal display devices that includes switching elements such as thin film diodes (TFDs) or thin film transistors (TFTs), the counter electrode normally need not be greatly processed. Particularly when the switching elements are TFTs, the counter electrode is an integral layer that need not be greatly processed (etched, for example) beyond its formation. If the configuration of Japanese Unexamined Patent Application Publication No. 2002-202511 were used for an active matrix device, then special processes would need to be performed to provide the concave portions in the counter electrode. This would result in an increase in Takt time and a raise in manufacturing costs.

A liquid crystal display device according to one aspect of the present invention includes a plurality of dot regions arranged in a matrix. The liquid crystal display device includes a first substrate, a second substrate, a liquid crystal layer, an insulating film, and substantially island-shaped electrodes.

The second substrate opposes the first substrate. The liquid crystal layer is interposed between the first substrate and the second substrate, ad includes liquid crystal molecules having a negative dielectric anisotropy resulting in vertical alignment in an initial alignment state.

The insulating film is disposed between the liquid crystal layer and the first substrate. The insulating film includes a plurality of concave portions located at positions overlapping the center of each dot region.

The substantially island-shaped electrodes are provided over the insulating film. The electrodes follow the contour of the concave portions of the insulating film to form concave portions in the electrodes. The concave portions in the electrodes control alignment direction of the molecules in the liquid crystal layer.

In the present specification, when a color liquid crystal display device is constructed such that R (red), G (green), and B (blue) dots constitute one pixel, a display region, which is a minimal display unit, is referred to as a ‘dot region’.

The liquid crystal display device according to the aspect of the present invention adopts a vertical alignment mode in which liquid crystal vertically aligned in an initial alignment state and having a negative dielectric anisotropy is used. Therefore, an action in which an electric field is distorted from the normal direction of the substrate by providing the concave portions for alignment control at the centers of the respective dot regions, and liquid crystal molecules are inclined by the concave portions is different from an action in which the electric field applied to the liquid crystal in the edge of the first electrode is distorted from the normal direction of the substrate, which makes it possible to radially align the liquid crystal molecules with respect to the center of each dot region. Therefore, it is possible to realize a liquid crystal display device having a wide viewing angle. As such, since the alignment of the liquid crystal layer can be sufficiently controlled by only structure at the first substrate side (i.e., the switching element side), it is not necessary to provide alignment control structure on the second substrate side (i.e., on the counter electrode substrate side, and for example, the second electrode may be formed in a solid layer without the need to form any holes or concaves therein. Therefore, there will be no increase in Takt time or in manufacturing costs. In addition, it is possible to prevent defects in display, such as the generation of color irregularity and an after image and the lowering of a response speed, without being affected by the positional deviation between the element substrate and the counter substrate in manufacture.

Further, the first electrodes are preferably formed substantially in a circular shape, an elliptical shape, or a polygonal shape in plan view. In this case, the liquid crystal molecules are smoothly aligned, and thus it is possible to equally widen a viewing angle in all directions.

In addition, the insulating film may cover the switching element. Contact holes may pass through the insulating film to electrically connect the switching elements to the first electrodes. According to this structure, since the switching elements are covered with the insulating film, the first electrodes and the switching elements and wiring lines connected to the switching element are arranged with the insulating film interposed therebetween. Therefore, it is possible to reduce parasitic capacitance.

Also, contact holes are absolutely necessary when the switching elements and the first electrodes are electrically connected to each other with the insulating film interposed therebetween,. Therefore, when the contact holes also serve as the concave portions for alignment control, it is not necessary to separately provide the contact holes. Thus, it is possible to reduce the area taken up by contact holes.

Alternately, the contact holes may be separately provided from the concave portions for alignment control. This configuration is beneficial when the contact holes are provided at the centers of the first electrodes due to the shape of the first electrode, because this causes a wiring region to be widened and an aperture ration to be lowered.

The first electrodes may be a plurality of island-shaped portions and connecting portions for connecting the plurality of island-shaped portions in each dot region.

In this case, when each dot region is formed in, for example, a rectangular shape in plan view, the island-shaped portion of the electrode can be formed such that the aspect ratio of thereof is close to 1:1 by dividing each electrode into the plurality of island-shaped portions, and it is possible to align the liquid crystal molecules in the same direction.

Moreover, in the above-mentioned structure, the island-shaped portions of the respective first electrodes are preferably formed substantially in a circular shape, an elliptical shape, or a polygonal shape in plan view.

Furthermore, in the liquid crystal display device according to the aspect of the present invention, a light shielding layer is preferably provided on the regions where the concave portions for alignment control are provided.

When the concave portions for alignment control are provided, it is possible to radially align the liquid crystal molecules in the vicinity of the concave portions. However, in this case, the liquid crystal molecules immediately above the concave portions are aligned in disorder. Therefore, in order to prevent the leakage of light caused by the alignment disorder (disclination), it is preferable to provide the light shielding layer on the regions where the concave portions for alignment control are formed.

In this case, the light shielding layer is preferably provided in the same layer where the switching elements are formed. According to this structure, an additional layer for forming the light shielding layer is not needed. Therefore, it is possible to simplify the structure of the liquid crystal display device.

Furthermore, according to the present invention, as described above, the alignment control of the liquid crystal layer can be performed solely by structure of the first substrate. However, other structure for liquid crystal alignment control may be provided on the second substrate. For example, slits or projections may be provided on the second electrode and used for alignment control. In this case, as will be described later, it is necessary to set the dimensions of the alignment control means provided in the second substrate can be set so as not to be influenced by an assembly error.

Moreover, it is preferable that the concave portions in the electrodes be formed at the same time as the contact holes. As a result, it is not necessary to perform two separate processes for forming the concave portions and for forming the contact holes. Manufacture is that much easier and shorter.

Further, the light shielding layer may be formed at the same time that electrodes of the switching elements are formed. As a result, it is not necessary to separately form the light shielding layer from the electrode of the switching elements. Manufacture is that much easier and shorter.

An electronic apparatus of the present invention has the liquid crystal display device according to the aspect of the present invention. According to this structure, it is possible to realize an electronic apparatus having a liquid crystal display device having a wide viewing angle, high response speed, and no defect in display.

### BRIEF DESCRIPTION OF THE DRAWINGS

The invention will be described with reference to the accompanying drawings, wherein like numbers reference like elements, and wherein:

FIG. 1 is an equivalent circuit diagram of a liquid crystal display device according to a first embodiment of the present invention;

FIG. 2 is a plan view illustrating the structure of dot regions of the liquid crystal display device according to the first embodiment;

FIG. 3 is a plan view illustrating one pixel of the liquid crystal display device according to the first embodiment;

FIG. 4 is a cross-sectional view taken along the line A-A′ of FIG. 3;

FIG. 5 is a plan view illustrating one pixel of a liquid crystal display device according to a second embodiment of the present invention;

FIG. 6 is a cross-sectional view taken along the line A-A′ of FIG. 5;

FIG. 7 is a plan view illustrating one pixel of a liquid crystal display device according to a third embodiment of the present invention;

FIG. 8 is a cross-sectional view taken along the line A-A′ of FIG. 7;

FIG. 9 is a plan view illustrating one pixel of a liquid crystal display device according to a fourth embodiment of the present invention;

FIG. 10 is a cross-sectional view taken along the line A-A′ of FIG. 9;

FIG. 11 is a plan view illustrating one pixel of a liquid crystal display device according to a fifth embodiment of the present invention;

FIG. 12 is a plan view illustrating one pixel of a liquid crystal display device according to a sixth embodiment of the present invention;

FIG. 13 is a cross-sectional view taken along the line A-A′ of FIG. 12;

FIG. 14 is a plan view illustrating one pixel of a liquid crystal display device according to a seventh embodiment of the present invention;

FIG. 15 is a perspective view illustrating an example of an electronic apparatus according to the present invention; and

FIG. 16 is an explanatory view illustrating the operation of a concave portion for alignment control in the present embodiment.

### DETAILED DESCRIPTION OF THE EMBODIMENTS

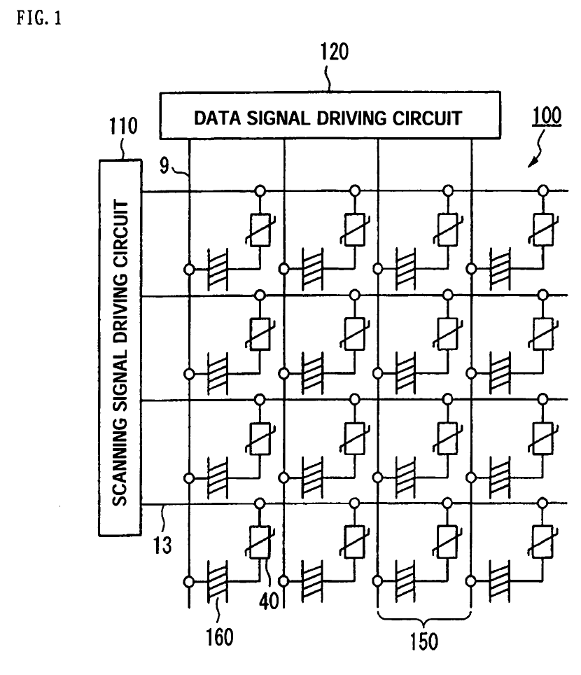

Hereinafter, a first embodiment of the present invention will be described with reference to FIGS. 1 to 4.

An active matrix liquid crystal display device using thin film diodes (hereinafter, abbreviated to as TFDs) as pixel switching elements, particularly, a transmissive liquid crystal display device capable of performing transmissive display is taken as an example of a liquid crystal display device according to the present embodiment. In addition, in order to make each layer and each member recognizable in the drawings, each layer and each member have different reduced scales.

FIG. 1 shows an equivalent circuit diagram of a liquid crystal display device 100 according to the present embodiment. The liquid crystal display device 100 includes a scanning signal driving circuit 110 and a data signal driving circuit 120. The liquid crystal display device 100 is provided with signal lines, that is, a plurality of scanning lines 13 and a plurality of data lines 9 intersecting the scanning lines 13. The scanning lines 13 are driven by the scanning signal driving circuit 110, and the data lines 9 are driven by the data signal driving circuit 120. In each pixel region 150, a TFD element 40 and a liquid crystal display element 160 (a liquid crystal layer) are connected to each other in series between the scanning line 13 and the data line 9. In FIG. 1, the TFD element 40 is connected to the scanning line 40, and the liquid crystal display element 160 is connected to the data line 9. However, on the contrary, the TFD element 40 may be connected to the data line 9, and the liquid crystal display element 160 may be connected to the scanning line 13.

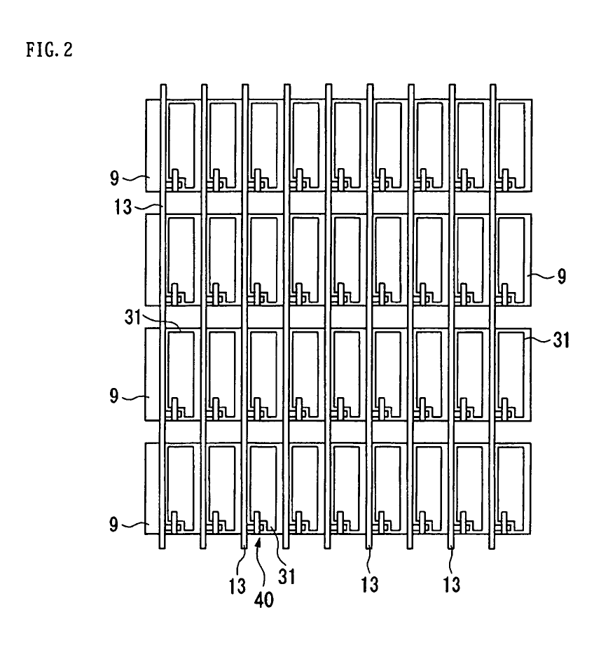

Next, the plane structure (pixel structure) of an electrode of the liquid crystal display device 100 according to the present embodiment will be described with reference to FIG. 2.

As shown in FIG. 2, in the liquid crystal display device 100 of the present embodiment, pixel electrodes 31 (first electrodes) connected to the scanning lines 13 through the TFD elements 40 are provided in a matrix, and a counter electrode 9 (second electrode) is provided in a stripe shape so as to be opposite to the pixel electrodes 31 in a direction perpendicular to the plane of FIG. 2. The counter electrode 9 serves as the above-mentioned data line and has a stripe shape perpendicular to the scanning line 13. In the present embodiment, each region in which the pixel electrode 31 is formed is a dot region, and the dot regions arranged in a matrix are respectively provided with the TFD elements 40, so that each dot region can perform display.

In FIG. 2, each pixel electrode is shown substantially in a rectangular shape, but has actually three island-shaped portions and two connecting portions, which will be described later. Here, the TFD element 40 is a switching element for electrically connecting the scanning line 13 to the pixel electrode 31 and is formed in an MIM (Metal-Insulator-Metal) structure having a first electrode containing Ta as the main ingredient, an insulating film formed on the surface of the first electrode and containing Ta₂O₃ as the main ingredient, and a second electrode formed on the surface of the insulating film and containing Cr as the main ingredient. Further, the first electrode of the TFD element 40 is connected to the scanning line 13, and the second electrode thereof is connected to the pixel electrode 31.

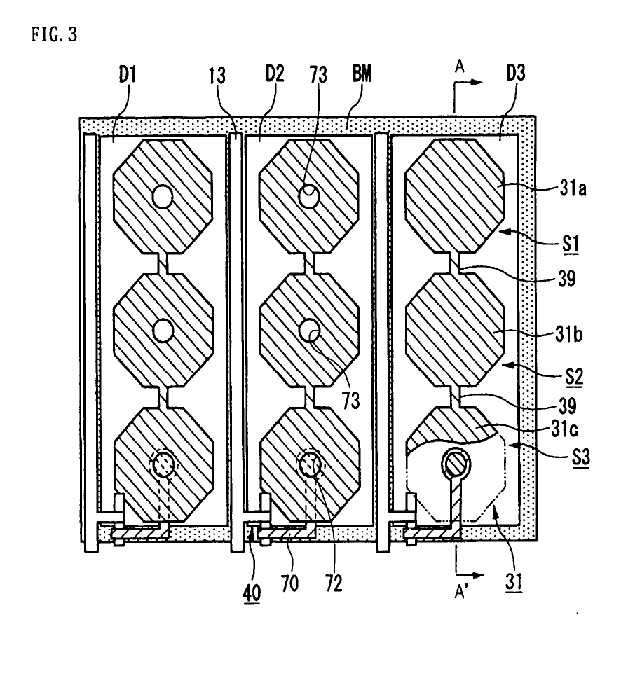

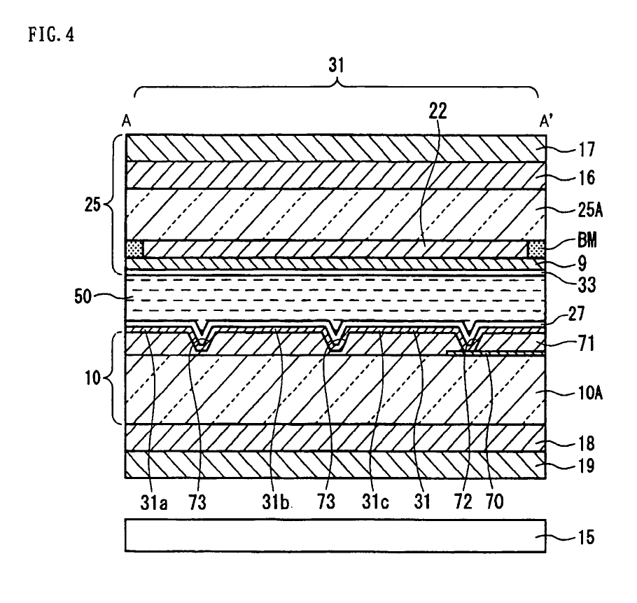

Next, the pixel structure of the liquid crystal display device 100 according to the present embodiment will be described with reference to FIGS. 3 and 4. FIG. 3 is a view schematically illustrating the pixel structure of the liquid crystal display device 100, particularly the plane structure of the pixel electrode 31. FIG. 4 is a cross-sectional view taken along the line A-A′ of FIG. 3.

As shown in FIG. 2, in the liquid crystal display device 100 of the present embodiment, the pixel electrodes 31 are respectively formed in dot regions surrounded by the data lines 9 and the scanning lines 13. As shown in FIG. 3, in the dot regions, a colored layer having any one of the three primary colors is provided in one dot region, and three dot regions (D1, D2, and D3) constitute one pixel including red, green, and blue.

As shown in FIG. 4, in the liquid crystal display device 100 according to the present embodiment, as seen from the upper side (the user side), a liquid crystal layer 50 which is made of a liquid crystal material that has a negative dielectric anisotropy, and so is vertically aligned in an initial state, is interposed between a lower substrate 10 (an element substrate, that is, a first substrate) and an upper substrate 25 (a counter substrate, that is, a second substrate) opposite to the lower substrate 10.

As shown in FIG. 4, in the lower substrate 10, the TFD elements (not shown in FIG. 4) are formed on an inner surface of a substrate body 10A (a surface of the substrate body 10A facing the liquid crystal layer) made of a light transmissive material, such as a glass or a quartz. A second electrode 70 of the TFD element 40 extends into the inner surface of the substrate body 10A. Further, an interlayer insulting film 71 is formed so as to cover the TFD elements and a second electrode 70, which is formed from Cr. The pixel electrode 31 composed of a transparent conductive film made of, for example, an indium tin oxide (hereinafter, abbreviated to as ITO) and an alignment film 27 made of, for example, polyimide and having a vertical alignment function are sequentially formed on the interlayer insulating film 71. The alignment film 27 functions as a vertical alignment film for vertically aligning liquid crystal molecules with respect to the film surface, and an alignment process, such as rubbing, is not performed thereon.

As shown in FIG. 3, in the present embodiment, each pixel electrode 31 includes three island-shaped portions 31a, 31b, and 31c, and the island-shaped portions 31a, 31b, and 31c are electrically connected to each other through the connecting portions 39 to form the pixel electrode 31. That is, in the present embodiment, each dot region D1, D2, or D3 is divided into three sub-dot regions S1, S2, and S3 having substantially the same shape. In other words, each pixel electrode 31 on the lower substrate 10 includes three island-shaped portions 31a, 31b, and 31c and the connecting portions 39 for electrically connecting the respective island-shaped portions adjacent to each other, and the island-shaped portions 31a, 31b, and 31c constitute the sub-dot regions S1, S2, and S3, respectively.

Generally, the aspect ratio of one dot region is 3:1 in a color liquid crystal display device having color filters. Therefore, when three sub-dot regions S1, S2, and S3 are provided in each dot region D1, D2, or D3 as in the present embodiment, one sub-dot region is formed substantially in a circle shape or a regular polygon shape, which enables a viewing angle to be widen in all directions. Each sub-dot region S1, S2, or S3 (the island-shaped portion 31a, 31b, or 31c) is formed substantially in a regular octagon shape in FIG. 3, but the shape of the sub-dot region is not limited thereto. For example, the sub-dot region may be formed in a circle shape or polygon shapes other than the octagon shape. Further, the pixel electrode 31, a slit (a portion other than the connecting portions 39) formed by cutting out a portion of the electrode is formed among the respective island-shaped portions 31a, 31b, and 31c.

Furthermore, contact holes 72 are formed to pass through the interlayer insulating film 71, and the second electrode 70 and the pixel electrode 31 are electrically connected to each other through the contact hole 72. In the present embodiment, a leading end of the second electrode 70 of the TFD element 40 extends toward the center of the sub-dot region S3 (the island-shaped portion 31c) at the lower side of FIG. 3, and the contact hole 72 having a circular shape in plan view and a tapered shape in sectional view is formed at a portion where the leading end touches the center of the sub-dot region S3. The contact hole 72 also serves as a concave portion for alignment control. In addition, the leading end of the second electrode 70 located at the center of the sub-dot region S3 is formed in a circular shape having a diameter slightly larger than that of the contact hole 72, and functions as a light shielding portion for preventing the leakage of light caused by disclination generated in the contact hole portion.

Meanwhile, concave portions 73 for alignment control having a circular shape in plan view and a tapered shape in sectional view are respectively formed at the center of the sub-dot region S1 (the island-shaped portion 31a) located at the upper side of FIG. 3 and the center of the sub-dot region S2 (the island-shaped portion 31b) located at the center. As shown in FIG. 4, in two concave portions 73 for alignment control, the pixel electrode 31 is formed on the inner surface of the concave portion formed in the interlayer insulating film 71, similar to the contact hole 72. Therefore, the two concave portions 73 for alignment control are not connected to the second electrode 70 of the TFD element 40. In the present embodiment, the shapes and dimensions of the contact hole 72 and the concave portion 73 for alignment control are equal to each other, and the concave portion preferably has a depth larger than 0.05 μm in order to have an alignment characteristic. In addition, the surface of the tapered portion is preferably inclined at an angle of 2° or more. Further, in order to suppress disclination to some extent, the surface of the tapered portion is preferably inclined at an angle of 20° or more.

In the upper substrate 25, a color filter 22 (one of a red colored layer, a green colored layer, and a blue colored layer) is provided on an inner surface of the substrate body 25A made of a transmissive material, such as glass or quartz. Here, the colored layer is surrounded by a black matrix BM made of metallic chrome, and the boundaries among the respective dot regions D1, D2, and D3 are defined by the black matrix BM (see FIG. 3). The counter electrode 9 composed of a transparent conductive film made of, for example, ITO is formed on the color filter 22, and the alignment film 33 made of, for example, polyimide and having a vertical alignment function is formed on the counter electrode 9. In addition, in FIG. 4, the counter electrode 9 is formed in a stripe shape extending orthogonal to the plane of the paper and functions as an electrode common to a plurality of dot regions arranged orthogonal to the plane of the paper.

Meanwhile, a retardation plate 18 and a polarizing plate 19 are sequentially formed on the outer surface of the lower substrate 10 (a surface of the lower substrate opposite to the liquid crystal layer 50), and a retardation plate 16 and a polarizing plate 17 are also sequentially provided on the outer surface of the upper substrate 25. In addition, a backlight 15, serving as a light source for transmissive display, is provided on the outer surface of the polarizing plate 19 on the lower substrate 10.

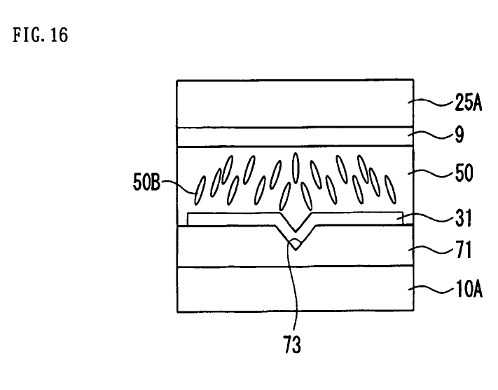

In the liquid crystal display device 100 of the present embodiment, the concave portions 73 for alignment control (including the contact holes 72 serving as the concave portions 73 for alignment control) are provided in the lower substrate 10 which corresponds to the centers of the respective sub-dot regions S1, S2, and S3. As shown in FIG. 16, an action in which an electric field is distorted from the normal direction of the substrate and liquid crystal molecules 50B are inclined due to the shape of the concave portion is different from an action in which an electric filed is distorted from the normal direction of the substrate at a circumferential portion of the electrode 31. Therefore, it is possible to radially align the liquid crystal molecules 50B with respect to the centers of the sub-dot regions S1, S2, and S3 when the electric field is applied thereto. In this way, it is possible to realize a liquid crystal display device having a wider viewing angle. As such, since the alignment of the liquid crystal layer 50 can be sufficiently controlled by only the structure of the lower substrate 10, it is not necessary to provide alignment means on the upper substrate 25, and for example, the counter electrode 9 can be formed in a general shape without any restrictions.

Particularly, in the case of the present embodiment, the contract hole 72 and the concave portion 73 for alignment control have completely the same shape and dimensions and are formed in the same process. Therefore, in an active matrix liquid crystal display device, the contact hole forming process is indispensable, but it is not necessary to separately provide a process for forming the concave portion 73 for alignment control from the contact hole forming process, which results in a simple and short manufacturing process. As such, it is possible to settle problems of an increase in Takt time and a raise in manufacturing costs. In addition, the positional deviation between the lower substrate 10 and the upper substrate 25 does not occur in manufacture, unlike the conventional structure in which alignment control means must be formed on both substrates, which makes it possible to prevent defects in display, such as the generation of stain-shaped color irregularity and an after image and the lowering of a response speed.

Further, the contact hole 72 and the concave portion 73 for alignment control may have different shapes and dimensions. Since the contact hole 72 needs to be electrically connected to the second electrode 70 with low resistance, it is impossible to excessively decrease the size of the contact hole 72. On the other hand, it is possible to decrease the size of the concave potion 73 for alignment control within the range where alignment can be controlled. The occupation area of the concave portion is decreased by reducing the size of the concave portion 73 for alignment control, and thus it is possible to suppress the lowering of an aperture ratio. In addition, in the type in which one dot region is divided into three sub-dots, in order to realize a high aperture ratio while maintaining the symmetry of the shape of the sub-dot, it is preferable to arrange the contact holes 72 at the centers of the island-shaped portions 31a, 31b, and 31c of the pixel electrode 31 as in the present embodiment. Further, three concave portions 73 for alignment control may be respectively provided at the centers of the sub-dot regions S1, S2, and S3, and the contact holes 72 may be separately provided outside the pixel electrode 31.

Furthermore, a portion of the second electrode 70 of the TFD element 40 functions to prevent the leakage of light caused by disclination generated in the contact hole 72. However, a light shielding layer having the same layout as the second electrode 70 may be provided in the regions where the remaining two concave portions 73 for alignment control are formed. The formation of the concave portion 73 for alignment control makes it possible to radially control the alignment of liquid crystal molecules around the concave portion 73 for alignment control. In this case, the alignment of the liquid crystal molecules is disarranged immediately above the concave portion 73 for alignment control, so that it is possible to prevent the leakage of light caused by disclination.

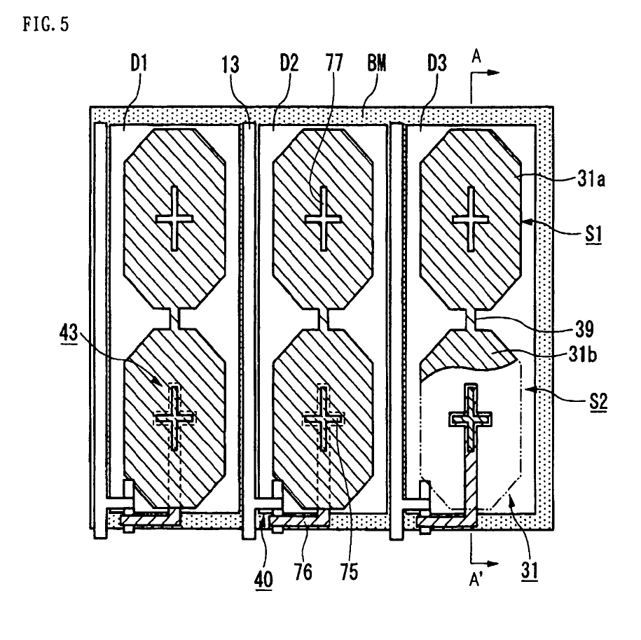

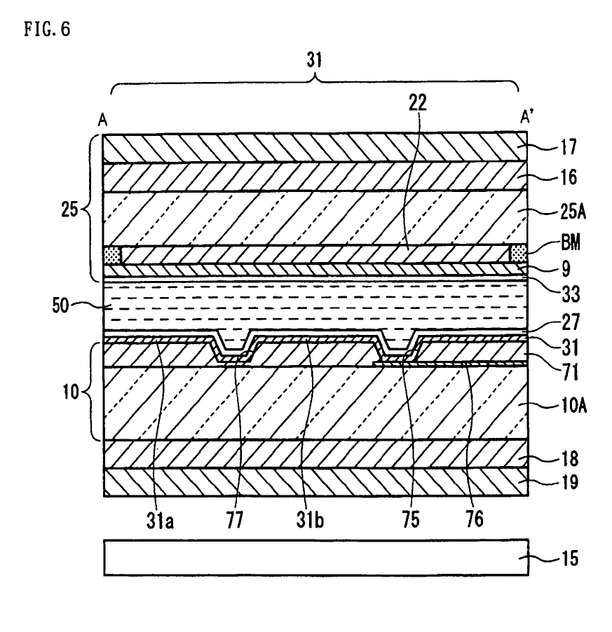

Hereinafter, a second embodiment of the present invention will be described with reference to FIGS. 5 and 6.

FIG. 5 is a plan view of one pixel of a liquid crystal display device according to the present embodiment and corresponds to FIG. 3 of the first embodiment. FIG. 6 is a cross-sectional view taken along the line A-A′ of FIG. 5 and corresponds to FIG. 4 of the first embodiment. The basic structure of the liquid crystal display device according to the present embodiment is the same as that in the first embodiment except for the number of divided sub-dots regions and the shape of the concave portion for alignment control. Therefore, in FIGS. 5 and 6, the same components as those in FIGS. 3 and 4 have the same reference numerals, and a detailed description thereof will be omitted.

In the first embodiment, one dot region is divided into three sub-dots regions, and the circular concave portions for alignment control and the contact holes are formed at the centers of the respective sub-dot regions. However, in the liquid crystal display device of the present embodiment, as shown in FIG. 5, each dot region D1, D2, or D3 is divided into two sub-dot regions S1 and S2. Therefore, each sub-dot region S1 or S2 is formed in a longitudinal octagon shape. That is, one pixel electrode 31 has two island-shaped portions 31a and 31b, and the two island-shaped portions 31a and 31b are connected to each other through one connecting portion 39.

Further, a cross-shaped contact hole 75 having four branches extending from the center of the sub-dot region S2 toward the edge thereof is formed at the center of the island-shaped portion 31b located at the lower side of FIG. 5. As shown in FIG. 6, a second electrode 76 of the TFD element 40 extends in a cross shape on the lower side of the contact hole 75, so that the pixel electrode 31 and the second electrode 76 are electrically connected to each other. The contact hole 75 also serves as a concave portion for alignment control. In addition, a concave portion 77 for alignment control having the same shape and dimensions as the contact hole 75 is formed at the center of the island-shaped portion 31a located at the lower side of FIG. 5. Further, in the present embodiment, since the respective island-shaped portions 31a and 31b are longitudinally formed, the cross-shaped contact hole 75 is formed such that the branches thereof extending in the vertical direction of FIG. 5 are longer than the branches thereof extending in the horizontal direction.

In the liquid crystal display device of the present embodiment, it is also possible to reliably prevent defects in display, such as color irregularity, an after image, and the lowering of a response speed, without increasing loads in manufacture and being influenced by the positional deviation between the upper substrate and the lower substrate, and thus it is possible to obtain the same effects as those in the first embodiment. In addition, in the present embodiment, since the concave portion 77 for alignment control has a cross shape, the distance from alignment control means to the edge of the pixel electrode is short, so that it is possible to increase alignment regulating force.

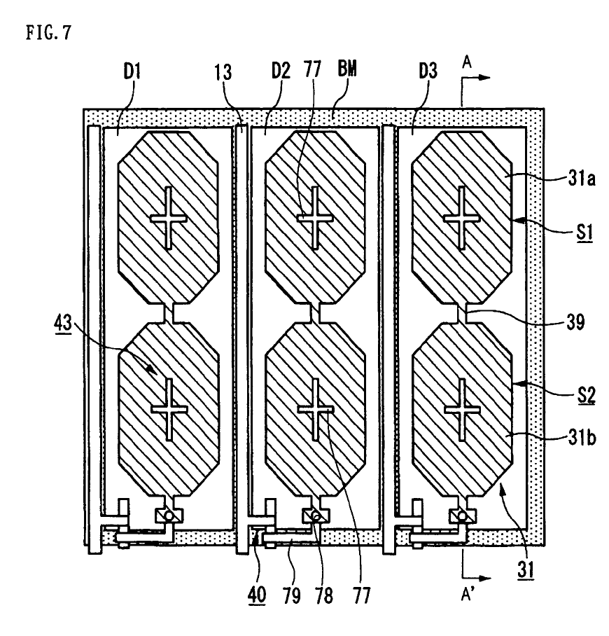

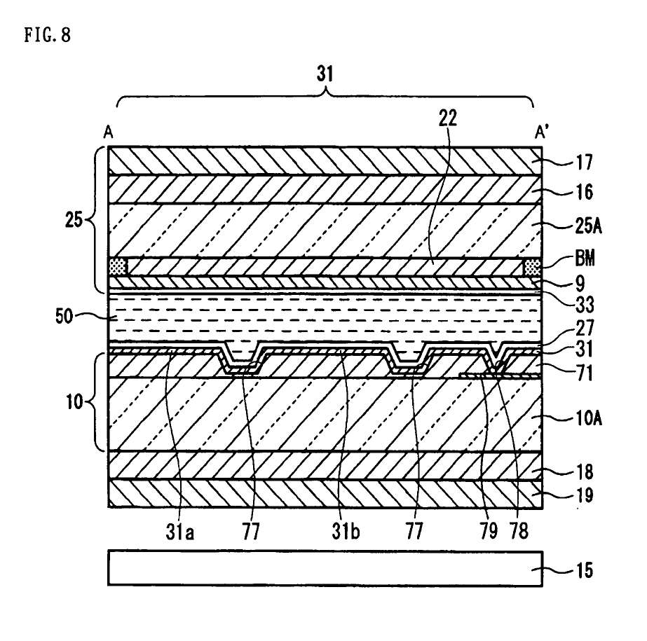

Hereinafter, a third embodiment of the present invention will be described with reference to FIGS. 7 and 8.

FIG. 7 is a plan view of one pixel of a liquid crystal display device according to the present embodiment and corresponds to FIG. 3 of the first embodiment. FIG. 8 is a cross-sectional view taken along the line A-A′ of FIG. 7 and corresponds to FIG. 4 of the first embodiment. The basic structure of the liquid crystal display device according to the present embodiment is the same as those in the first and second embodiments except that the position of the contact hole is different from that in the second embodiment. Therefore, in FIGS. 7 and 8, the same components as those in FIGS. 3 and 4 have the same reference numerals, and a detailed description thereof will be omitted.

In the second embodiment, the contact hole, serving as the concave portion for alignment control, is formed at the center of one of two sub-dot regions. However, in the liquid crystal display device of the present embodiment, as shown in FIG. 7, cross-shaped concave portions 77 for alignment control are formed at the centers of two sub-dot regions S1 and S2, that is, at the centers of two island-shaped portions 31a and 31b, respectively. Further, a contact hole 78 is separately formed at the lower side of the sub-dot region S2 in FIG. 7. Therefore, as shown in FIG. 8, a second electrode 79 of the TFD element 40 extends up to the lower side of the contact hole 78, so that the pixel electrode 31 and the second electrode 79 are electrically connected to each other. The second electrode 79 of the TFD element 40 does not extend up to the center of the sub-dot region S2.

In the liquid crystal display device of the present embodiment, it is also possible to reliably prevent defects in display, such as color irregularity, an after image, and the lowering of a response speed, without increasing loads in manufacture and being influenced by the positional deviation between the upper substrate and the lower substrate, and thus it is possible to obtain the same effects as those in the first embodiment. In addition, it is possible to increase alignment regulating force, similar to the second embodiment by making a concave portion 77 for alignment control have a cross-shape. As such, in the type in which one dot region is divided into two sub-dot region or in the type in which one dot region is not divided into sub-dot regions, when the contact hole is provided at the center of the sub-dot region or the dot region, a wiring region is increase, and an aperture ratio is lowered according to circumstances. Therefore, it is effective to provide the contact hole at the outside of the sub-dot region and the dot region according to precision.

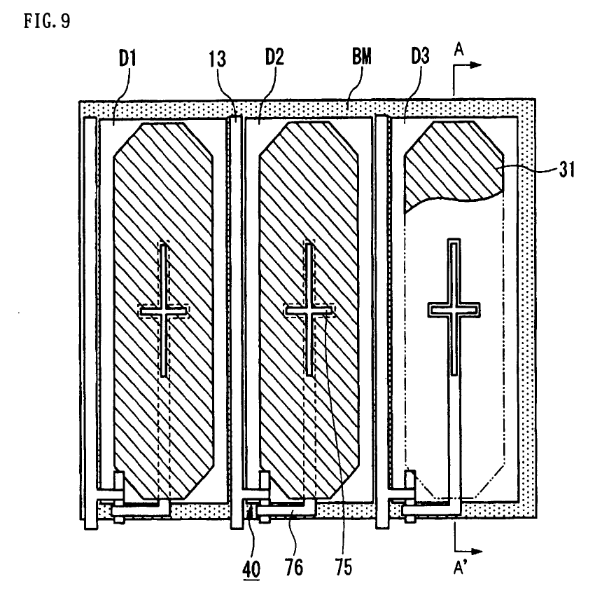

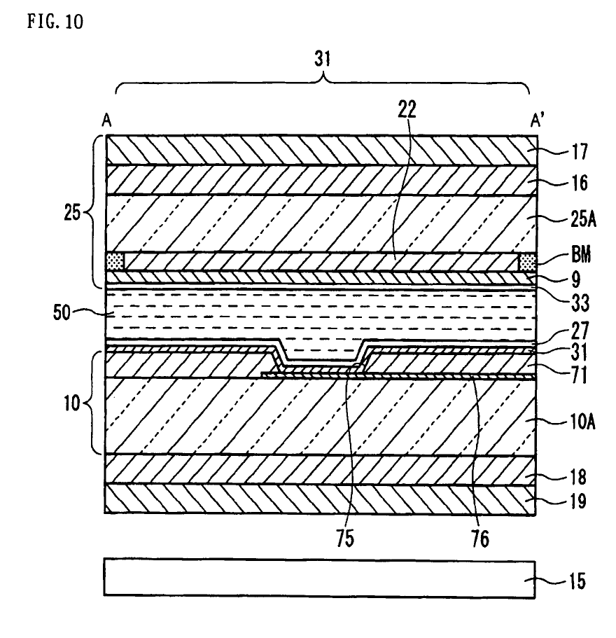

Hereinafter, a fourth embodiment of the present invention will be described with reference to FIGS. 9 and 10.

FIG. 9 is a plan view of one pixel of a liquid crystal display device according to the present embodiment and corresponds to FIG. 3 of the first embodiment. FIG. 10 is a cross-sectional view taken along the line A-A′ of FIG. 9 and corresponds to FIG. 4 of the first embodiment. The basic structure of the liquid crystal display device according to the present embodiment is the same as those in the first to third embodiments except that one dot region is not divided into sub-dot regions. Therefore, in FIGS. 9 and 10, the same components as those in FIGS. 3 and 4 have the same reference numerals, and a detailed description thereof will be omitted.

In the first to third embodiments, one dot region is divided into a plurality of sub-dot regions, and the concave portions for alignment control are respectively formed at the centers of the sub-dot regions. However, in the liquid crystal display device of the present embodiment, as shown in FIG. 9, each dot region D1, D2, or D3 is not divided into sub-dot regions. A cross-shaped contact hole 75 id formed at the center of the pixel electrode 31. As shown in FIG. 10, the second electrode 76 of the TFD element 40 extends in a cross shape at the lower side of the contact hole 75, so that the pixel electrode 31 and the second electrode 76 are electrically connected to each other. The contact hole 75 also serves as a concave portion for alignment control.

In the liquid crystal display device of the present embodiment, it is also possible to reliably prevent defects in display, such as color irregularity, an after image, and the lowering of a response speed, without increasing loads in manufacture and being influenced by the positional deviation between the upper substrate and the lower substrate, and thus it is possible to obtain the same effects as those in the first to third embodiments. In addition, in the present embodiment, since one dot region is not divided into sub-dot regions, there is an effect of increasing an aperture ratio. Such an effect is remarkably obtained in a high-precision range greater than 170 ppi. Therefore, a liquid crystal display device capable of performing bright display can be achieved. For example, it is not necessary to provide sub-dot regions in a case in which the size of a pixel is very small and the aspect ratio of a dot region is about 1:1 as in a liquid crystal display device for a light value of a three-sheet-type projection display device.

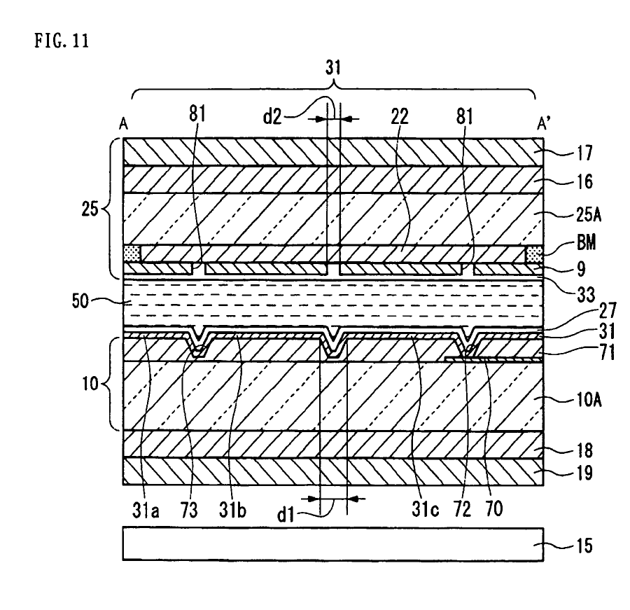

Hereinafter, a fifth embodiment of the present invention will be described with reference to FIG. 11.

FIG. 11 is a plan view of one pixel of a liquid crystal display device according to the present embodiment and corresponds to FIG. 4 of the first embodiment. The basic structure and plane shape of the liquid crystal display device according to the present embodiment are the same as those in the first embodiment, and thus a plan view thereof is omitted. Therefore, in FIG. 11, the same components as those in FIG. 4 have the same reference numerals, and a detailed description thereof will be omitted.

In the first embodiment, alignment control means is not provided on the counter electrode. However, in the liquid crystal display device of the present embodiment, as shown in FIG. 11, the contact holes 72 and the concave portions 73 for alignment control are provided in the lower substrate 10, similar to the first embodiment, and apertures 81 are formed in the counter electrode 9 in the supper substrate 25 at positions corresponding to the contact holes 72 and the concave portions 73 for alignment control. The contact hole 72 and the concave portions 73 for alignment control in the lower substrate 10 and the apertures 81 in the upper substrate 25 all have a circular shape, but have different sizes. The aperture 81 in the upper substrate 25 is smaller than the contact hole 72 and the concave portion 73 for alignment control in the lower substrate 10. In addition, when the diameters of the contact hole 72 and the concave portion 73 for alignment control is d1, the diameter of the aperture 81 is d2, and the maximum value of the positional deviation between the upper substrate and the lower substrate in bonding is z, it is preferable that the relationship d1>d2+z×2 be established. As long as the relationship is established, a defect in alignment does not occur even when the maximum of misalignment between the upper substrate and the lower substrate occurs. This is because the concave portions 73 are positioned opposite to the apertures 81.

In the liquid crystal display device of the present embodiment, alignment control means composed of the aperture 81 is also formed on the upper substrate 25. Therefore, since the alignment regulating force by the apertures 81 of the counter electrode 9 is complementarily added to the alignment regulating force by the concave portions 73 for alignment control in the lower substrate 10, it is possible to obtain more stable alignment, and thus to improve a response speed. As the result of comparing a response speed using, the conventional structure in which only the slit is provided in the electrode has a response speed of 40 msec, and the structure of the present embodiment has a response speed of 35 msec. Therefore, the present embodiment can improve the response speed. In addition, although a process of forming the apertures 81 in the counter electrode 9 of the upper substrate 25 is needed, the number of processes is not increased as a whole in the case of an active matrix liquid crystal display device using TFDs. This is because the apertures can be simultaneously formed in the process of patterning the counter electrode in a stripe shape.

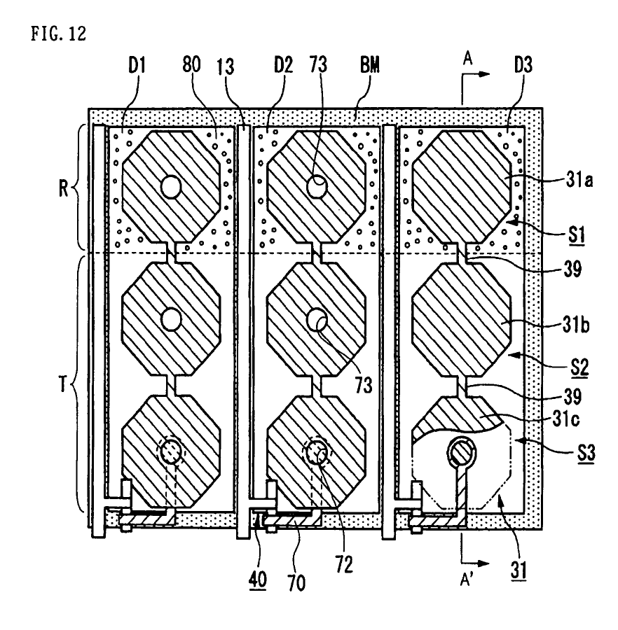

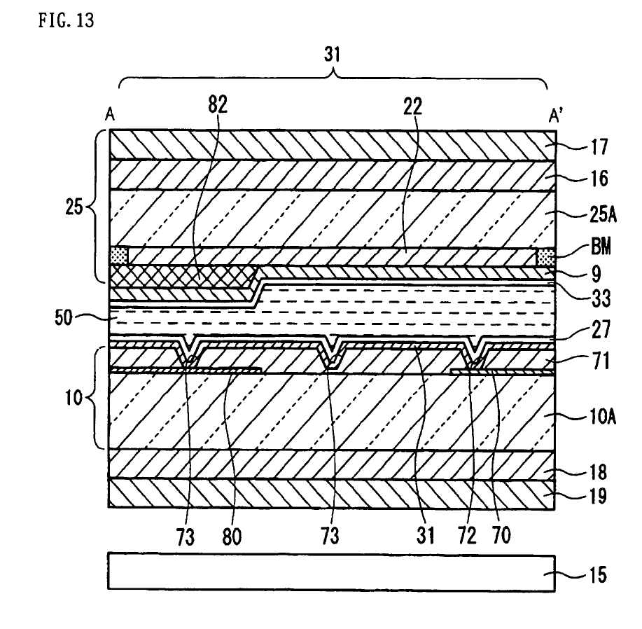

Hereinafter, a sixth embodiment of the present invention will be described with reference to FIGS. 12 and 13.

FIG. 12 is a plan view of one pixel of a liquid crystal display device according to the present embodiment and corresponds to FIG. 3 of the first embodiment. FIG. 13 is a cross-sectional view taken along the line A-A′ of FIG. 12 and corresponds to FIG. 4 of the first embodiment. In the first to fifth embodiments, the transmissive liquid crystal display device is taken as an example. However, in the present embodiment, a transflective liquid crystal display device having both a transmissive display mode and a reflective display mode is described as an example of a display device. In addition, a plane pattern shape of the liquid crystal display device according to the present embodiment is similar to that in the first embodiment. Therefore, in FIGS. 12 and 13, the same components as those in FIGS. 3 and 4 have the same reference numerals, and a detailed description thereof will be omitted.

In the liquid crystal display device of the present embodiment, as shown in FIG. 12, two sub-dot regions S2 and S3 respectively located at the center and the lower side of FIG. 12 among three sub-dot regions S1, S2, and S3 in each dot region D1, D2, and D3 are transmissive display regions T contributing to transmissive display, and the other sub-dot region S1 located at the upper side of FIG. 12 is a reflective display region R contributing to reflective display. In the lower substrate 10, as shown in FIG. 13, a reflective layer 80 made of a metallic material having high reflectance, such as aluminum, is formed on the inner surface of the substrate body 10A to touch the sub-dot region S1 located at the upper side of FIG. 12. In addition, a layer 82 for adjusting the thickness of the liquid crystal layer made of, for example, an acrylic resin is formed on the inner surface of the upper substrate 25 corresponding to the reflective display region R. The layer 82 for adjusting the thickness of the liquid crystal layer protrudes toward the liquid crystal layer 50, and the thickness thereof is suitably set such that the thickness of the liquid crystal layer in the reflective display region R is about half the thickness of the liquid crystal layer in the transmissive display region T.

In the liquid crystal display device of the present embodiment, it is also possible to reliably prevent defects in display, such as color irregularity, an after image, and the lowering of a response speed, without increasing loads in manufacture and being influenced by the positional deviation between the upper substrate and the lower substrate, and thus it is possible to obtain the same effects as those in the first to fifth embodiments. In the present embodiment, the presence of the layer 82 for adjusting the thickness of the liquid crystal layer causes the thickness of the liquid crystal layer in the reflective region R to be about half the thickness of the liquid crystal layer in the transmissive display region T. Therefore, it is possible to make the retardation of the reflective display region R substantially equal to that of the transmissive display region T. Thus, it is possible to realize a transflective liquid crystal display device having high contrast in both reflective display and transmissive display.

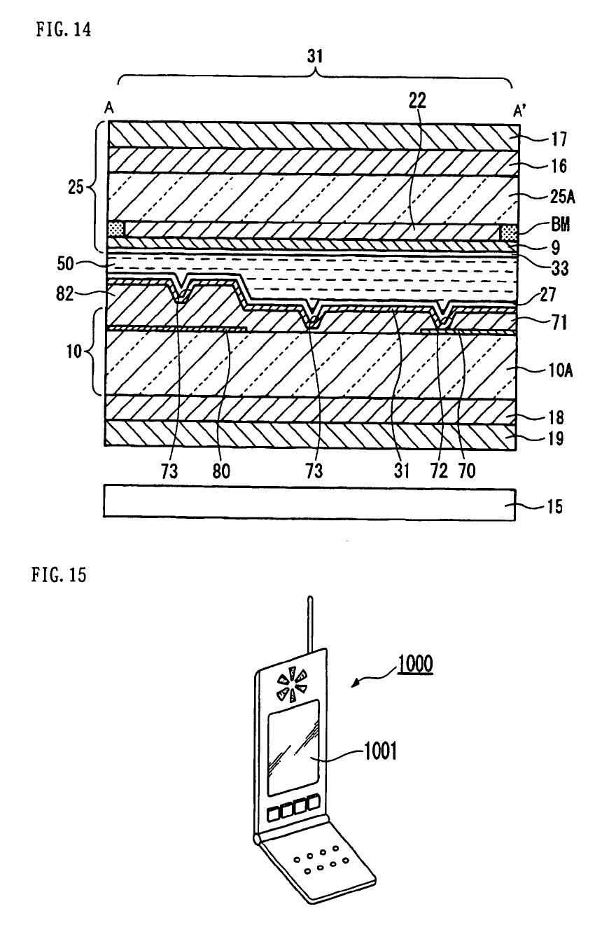

Hereinafter, a seventh embodiment of the present invention will be described with reference to FIG. 14.

FIG. 14 is a plan view of one pixel of a liquid crystal display device according to the present embodiment and corresponds to FIG. 4 of the first embodiment. Similar to the sixth embodiment, the present embodiment is described using the transflective liquid crystal display device as an example. The basic structure and plane shape of the liquid crystal display device according to the present embodiment are the same as those in the sixth embodiment, and thus a plan view thereof is omitted. In addition, in FIG. 14, the same components as those in FIG. 4 have the same reference numerals, and a detailed description thereof will be omitted.

In the sixth embodiment, the layer for adjusting the thickness of the liquid crystal layer is formed on the upper substrate. However, in the liquid crystal display device of the present embodiment, as shown in FIG. 14, the layer 82 for adjusting the thickness of the liquid crystal layer made of, for example, an acrylic resin is formed on the inner surface of the lower substrate 10 corresponding to the reflective display region R. The layer 82 for adjusting the thickness of the liquid crystal layer protrudes toward the liquid crystal layer 50, and the thickness thereof is suitably set such that the thickness of the liquid crystal layer in the reflective display region R is about half the thickness of the liquid crystal layer in the transmissive display region T. The lower substrate is an element substrate, and the interlayer insulating film 71 is formed underneath the pixel electrode 31. Therefore, the present embodiment adopts a two-layered structure of the interlayer insulating film 71 and the layer for adjusting the thickness of the liquid crystal layer formed thereon may be used or a structure in which a step difference portion is provided in the interlayer insulating portion 71 and a portion having a large thickness functions as the layer for adjusting the thickness of the liquid crystal layer. When the latter is adopted, the step difference portion can be formed by performing half expose on the interlayer insulating film made of, for example, a photosensitive resin. Therefore, a process of forming the layer for adjusting the thickness of the liquid crystal layer is not needed.

In the liquid crystal display device of the present embodiment, it is also possible to reliably prevent defects in display, such as color irregularity, an after image, and the lowering of a response speed, without increasing loads in manufacture and being influenced by the positional deviation between the upper substrate and the lower substrate, and thus it is possible to obtain the same effects as those in the first to sixth embodiments. Further, it is possible to realize a transflective liquid crystal display device having high contrast in both reflective display and transmissive display, and thus it is possible to obtain the same effects as those in the sixth embodiment.

Next, an example of an electronic apparatus having the liquid crystal display device according to the above-mentioned embodiments of the present invention will be described.

FIG. 15 is a perspective view illustrating an example of a mobile phone. In FIG. 15, reference numeral 1000 indicates a mobile phone main body, and reference numeral 1001 indicates a display unit using the above-mentioned liquid crystal display device. When the liquid crystal display device according to the above-mentioned embodiment is used for a display unit of an electronic apparatus, such as a mobile phone, it is possible to realize an electronic apparatus equipped with a display unit having a wide viewing angle, a defect in display, and a high response speed.

Furthermore, the technical scope of the present invention is not limited to the above-mentioned embodiments, and various modifications and changes can be made without departing from the spirit and scope of the present invention. For example, in the above-mentioned embodiments, the concave portion for alignment control is formed in a circular or cross shape. However, the shape and dimensions of the concave portion for alignment control is not limited thereto, but may be changed in the various shapes and dimensions. In addition, the present invention is applied to the active matrix liquid crystal display device using the TFDs as switching elements, but may be applied to an active matrix liquid crystal display device using TFTs as switching elements, a passive matrix liquid crystal display device not having contact holes, etc.

1. A liquid crystal display device including a plurality of dot regions arranged in a matrix, the liquid crystal display device comprising:
a first substrate;
a second substrate opposing the first substrate;
a liquid crystal layer interposed between the first substrate and the second substrate, the liquid crystal layer including liquid crystal molecules having a negative dielectric anisotropy resulting in vertical alignment in an initial alignment state;
an insulating film disposed between the liquid crystal layer and the first substrate, the insulating film including a plurality of concave portions located at positions overlapping the center of each dot region; and
substantially island-shaped electrodes provided over the insulating film, the electrodes following the contour of the concave portions of the insulating film to form concave portions in the electrodes, the concave portions in the electrodes controlling alignment direction of the molecules in the liquid crystal layer.

2. The liquid crystal display device according to claim 1, wherein the electrodes are formed substantially in one of a circular shape, an elliptical shape, and a polygonal shape in plan view.

3. The liquid crystal display device according to claim 1, further comprising:
switching elements disposed between the first substrate and the liquid crystal layer;
contact holes passing through the insulating film to electrically connect the switching elements to the electrodes.

4. The liquid crystal display device according to claim 3, wherein the contact holes form the concave portions in the electrodes.

5. The liquid crystal display device according to claim 3, wherein the contact holes are provided independently from the concave portions in the electrodes.

6. The liquid crystal display device according to claim 1, wherein each of the electrodes includes:
a plurality of island-shaped portions in each dot region; and
a connecting portion that connects the island-shaped portions in each dot region to each other.

7. The liquid crystal display device according to claim 6, wherein the island-shaped portions are formed substantially in one of a circular shape, an elliptical shape, and a polygonal shape in plan view.

8. The liquid crystal display device according to claim 6, further comprising:
switching elements covered by the insulating film; and
contact holes passing through the insulating film to electrically connect the switching elements to the electrodes.

9. The liquid crystal display device according to claim 8, wherein each dot includes a plurality of sub-dot regions, each of the electrodes includes an electrode portion provided for each sub-dot region, each electrode portion including a concave portion, at least one of the concave portions of the electrode portions in each dot also serving as the contact hole.

10. The liquid crystal display device according to claim 8, wherein the contact hole is provided independently from the concave portion in the electrode provided in the plurality of sub-dot regions in each dot region.

11. The liquid crystal display device according to claim 1, further comprising a light shielding layer provided overlapping the concave portions in the electrodes in plan view.

12. The liquid crystal display device according to claim 11, further comprising switching elements, the light shielding layer being provided in the same layer where the switching elements are formed.

13. The liquid crystal display device according to claim 1, further comprising an alignment control layer provided over the second substrate.
